(19) United States
(12) Patent Application Publication
(10) Pub. No.: US 2018/0194886 A1
(43) Pub. Date: Jul. 12, 2018

(54) METHOD FOR MANUFACTURING A MALEIC ANHYDRIDE-GRAFTED ATACTIC POLYPROPYLENE

(71) Applicant: Chuh-Yung CHEN, Tainan City (TW)

(72) Inventors: Chuh-Yung CHEN, Tainan City (TW); Ming-Yuan SHEN, Tainan City (TW); Chin-Han CHANG, Tainan City (TW); Chen-Chien WANG, Tainan City (TW)

(21) Appl. No.: 15/403,994

(22) Filed: Jan. 11, 2017

(51) Int. Cl. C08F 255/02

(52) U.S. Cl. CPC C08F 255/02

(57) ABSTRACT

A method for manufacturing a maleic anhydride-grafted atactic polypropylene includes the steps of: a) mixing atactic polypropylene, maleic anhydride, a protective agent containing a cyclic amide or imide ring, and a solvent to prepare a mixture, wherein a ratio of an amount of the maleic anhydride to an amount of the atactic polypropylene is less than 1; and b) heating the mixture to an elevated temperature and adding an initiator solution dropwise to the mixture to obtain a product solution containing the maleic anhydride-grafted atactic polypropylene.

### FIELD

The disclosure relates to a method for manufacturing a grafted atactic polypropylene, and more particularly to a method for manufacturing a maleic anhydride-grafted atactic polypropylene.

### BACKGROUND

Polypropylenes have advantages of high impact resistance, high solvent resistance, and high corrosion resistance, and the like, and thus are widely applied in various products. However, polypropylenes are inferior in terms of low temperature impact resistance, aging resistance, and environmental resistance. For example, polypropylenes are liable to become yellow and brittle in an exterior environment. Therefore, it is necessary to modify polypropylenes in order to alleviate the aforesaid shortcomings.

However, it is undesirable to modify polypropylenes by subjecting propylene monomers to copolymerization with functional monomers because of the toxicity of Ziegler-Natta catalysts usually used for the copolymerization and other problems in the copolymerization.

In view of the aforesaid, polypropylenes are usually modified via a grafting reaction. Furthermore, since polypropylenes are sensitive to oxidative and photochemical reactions, they are usually grafted via a free-radical reaction. Examples of the functional monomers suitable for the grafting reaction of polypropylenes include maleic acids and anhydrides or esters thereof, itaconic acids and anhydrides or esters thereof, crotonic acids and anhydrides or esters thereof, acrylic acids, glycidyl methacrylates, vinyl trimethoxysilanes, and the like. Among them, maleic acids or acrylic acids are most commonly used for the grafting reaction. Maleic anhydride- or acrylic acid-functionalized polypropylenes are used primarily for two reasons. The first reason is to promote interfacial filler-polymer reactions with the aim of achieving adhesion in composites, e.g., glass fiber-polypropylene reinforcement. The second reason is to achieve coupling reactions with other functional polymers and promote compatibilization of immiscible polymer blends and alloys.

It is mentioned in Reactive Modifiers for Polymers, edited by S. Al-Malaika, Chapter 2, Page 107 that the reactivity and the grafting yield of maleic anhydride onto polypropylene is typically low owing to the low free-radical reactivity of maleic anhydride as a consequence of its structural characteristics. It is also mentioned in the book that the grafting yield may be affected by the state (for example, a solid state or a liquid state) and the solvent in which a grafting reaction is performed. However, the presently available maleic anhydride-grafted polypropylenes merely have a grafting yield not larger than 1%.

It is therefore desirable in the art to provide a method for manufacturing a maleic anhydride-grafted polypropylene having an increased grafting yield.

### SUMMARY

Therefore, an object of the disclosure is to provide a method for manufacturing a maleic acid-grafted atactic polypropylene having an increased grafting yield.

According to the disclosure, there is provided a method for manufacturing a maleic anhydride-grafted atactic polypropylene, which comprises the steps of:

a) mixing atactic polypropylene, maleic anhydride, a protective agent containing a cyclic amide or imide ring, and a solvent to prepare a mixture, wherein a ratio of an amount of the maleic anhydride to an amount of the atactic polypropylene is less than 1; and

b) heating the mixture to an elevated temperature and adding an initiator solution dropwise to the mixture to obtain a product solution containing the maleic anhydride-grafted atactic polypropylene.

In certain embodiments, the solvent is a lipophilic solvent.

In certain embodiments, the maleic anhydride is in an amount ranging from 2.3 to 9.4 parts by weight based on 10 parts by weight of the atactic polypropylene.

According to the disclosure, the grafting yield of maleic acid-grafted polypropylene may be effectively increased by using a protective agent containing acyclic amide or imide ring, and preferably, by performing a grafting reaction in the presence of a lipophilic solvent and by controlling the amount of maleic acid relative to the amount of atactic polypropylene. In addition, the effects of the maleic acid-grafted atactic polypropylene thus manufactured for subsequent reactions may be enhanced as well.

### BRIEF DESCRIPTION OF THE DRAWINGS

Other features and advantages of the disclosure will become apparent in the following detailed description of the embodiment (s) with reference to the accompanying drawings, of which:

FIG. 1 illustrates photographs showing appearances of a maleic acid-modified atactic polypropylene composition of Application Example 1 examined at various temperatures;

FIG. 2 illustrates photographs showing appearances of a maleic acid-modified atactic polypropylene composition of Application Example 2 examined at various temperatures;

FIG. 3 illustrates photographs showing appearances of a maleic acid-modified atactic polypropylene composition of Comparative Application Example 1 examined at various temperatures;

FIG. 4 illustrates a photograph showing a fractured surface of the maleic acid-modified atactic polypropylene composition of Application Example 1 after freezing and subsequent fracturing;

FIG. 5 illustrates photographs showing a fractured surface of the maleic acid-modified atactic polypropylene composition of Application Example 2 after freezing and subsequent fracturing;

FIG. 6 illustrates a photograph showing a fractured surface of the maleic acid-modified atactic polypropylene composition of Application Example 3 after freezing and subsequent fracturing;

FIG. 7 illustrates photographs showing a fractured surface of the maleic acid-modified atactic polypropylene composition of Comparative Application Example 1 after freezing and subsequent fracturing;

FIG. 8 illustrates a photograph showing a microstructure of a sample obtained from the maleic acid-modified atactic polypropylene composition of Application Example 2;

FIG. 9 illustrates a photograph showing a microstructure of a sample obtained from the maleic acid-modified atactic polypropylene composition of Application Example 3; and

FIG. 10 illustrates a photograph showing a microstructure of a sample obtained from the maleic acid-modified atactic polypropylene composition of Comparative Application Example 1.

### DETAILED DESCRIPTION

The method for manufacturing a maleic anhydride-grafted atactic polypropylene according to the disclosure comprises the steps of:

a) mixing atactic polypropylene, maleic anhydride, a protective agent containing a cyclic amide or imide ring, and a first solvent to prepare a mixture, wherein a ratio of an amount of the maleic anhydride to an amount of the atactic polypropylene is less than 1; and

b) heating the mixture to an elevated temperature and adding an initiator solution dropwise to the mixture to obtain a product solution containing the maleic anhydride-grafted atactic polypropylene.

In certain embodiments, the first solvent is a lipophilic solvent.

In certain embodiments, the maleic anhydride is in an amount ranging from 2.3 to 9.4 parts by weight based on 10 parts by weight of the atactic polypropylene.

In certain embodiments, the elevated temperature ranges from 80° C. to 200° C.

The method of the disclosure further includes, after step b), a step c) of subjecting the product solution to a liquid-liquid extraction using alcohol to remove the maleic anhydride-grafted atactic polypropylene from the product solution.

The protective agent containing a cyclic amide or imide ring is selected from the group consisting of propiolactam, butyrolactam, valerolactam, caprolactam, 2-pyrrolidinone, succinimide, and combinations thereof.

The lipophilic solvent is selected from the group consisting of chlorobenzene, xylene, benzene, toluene, and combinations thereof. The lipophilic solvent is used for dissolving atactic polypropylene so as to increase the amount of atactic polypropylene capable of performing a grafting reaction with maleic anhydride.

As described above, in certain embodiment, maleic anhydride is in an amount ranging from 2.3 to 9.4 parts by weight based on 10 parts by weight of atactic polypropylene in step a). When maleic anhydride is in an amount less than 2.3 parts by weight based on 10 parts by weight of atactic polypropylene, the amount of maleic anhydride is insufficient for satisfactory grafting reaction, which leads to a reduced grafting yield of maleic anhydride onto atactic polypropylene. When maleic anhydride is in an amount more than 9.4 parts by weight based on 10 parts by weight of atactic polypropylene, the grafting yield may not be further increased.

In certain embodiments, the protective agent containing a cyclic amide or imide ring is in an amount ranging from 2.6 to 16.2 parts by weight based on 10 parts by weight of atactic polypropylene. When the protective agent is in an amount less than 2.6 parts by weight based on 10 parts by weight of atactic polypropylene, the grafting yield may be reduced. When the protective agent is in an amount more than 16.2 parts by weight based on 10 parts by weight of atactic polypropylene, the grafting yield may not be further increased. It should be noted that the amount of protective agent may be adjusted when optional agents for aiding the grafting reaction are included in the mixture in step a).

Step a) is performed at a temperature such that the mixture is maintained in a homogeneous state. In certain embodiments, step a) is performed at a temperature ranging from 20 to 50° C.

In certain embodiments, the initiator solution used in step b) contains an initiator and a second solvent.

In certain embodiments, the second solvent is a lipophilic solvent.

The initiator is used for initiating a free-radical reaction for grafting maleic anhydride onto atactic polypropylene. Examples of the initiator suitable for the disclosure include, but are not limited to, 2,2-azobis(isobutyronitrile) (AIBN), t-butylperoxy isopropylcarbonate (BPIC), dibenzoyl peroxide (BPO), dicumyl peroxide, 2,3-dimethyl-2,3-diphenyl- butane (DMDPB), di-t-butyl peroxide (DTBP), 2,5-bis(t-butylperoxy)-2,5-dimethylhexane (DTBPH), 2,5-bis(t-butyl- peroxy)-2,5-dimethylhexyne (DTBPHY), bis(t-butylperoxyisopropyl)benzene (DTBPIB), bis(2-ethylhexyl) peroxydicarbonate (EHP), dilauroyl peroxide (LPO), t-butylcumyl peroxide (TBCP), t-butyl hydroperoxide (TBHP), t-butyl peroxybenzoate (TBPB), t-butylperoxy-2-ethylhexanoate (TBPEH), and t-butyl peroxypivalate (TBPP).

Examples of the lipophilic solvent (i.e., the second solvent) useful in the initiator solution are the same as examples of the lipophilic solvent (i.e., the first solvent) useful in step a).

The amount of the initiator may be adjusted according to the amounts of maleic anhydride and atactic polypropylene. In certain embodiments, the initiator is in an amount ranging from 2.8 to 17.3 parts by weight based on 10 parts by weight of atactic polypropylene.

In certain embodiments, the initiator solution further includes a thiol compound. The thiol compound is used as a chain transferring agent for transferring maleic anhydride free radicals which are less active and less reactive so as to permit free radicals to be reused. Examples of the thiol compound include, but are not limited to, 1-hexanethiol, dodecanethiol, 1,4-butanedithiol, 1,6-hexanedithiol, pentaerythritol tetra (3-mercapto butyrate), pentaerythritol tris (3-mercapto butyrate), pentaerythritol bis (3-mercapto butyrate), and pentaerythritol mono (3-mercapto butyrate). When the thiol compound is included in the initiator solution, the amount of the protective agent containing a cyclic amide or imide ring may be reduced. In certain embodiments, when the thiol compound is included in the initiator solution, the protective agent containing a cyclic amide or imide ring is in an amount ranging from 0.1 to 10 parts by weight based on 10 parts by weight of atactic polypropylene.

In certain embodiments, in step b), a total amount of the atactic polypropylene, the maleic anhydride, the protective agent, the initiator, and the optional thiol compound ranges from 5 to 25 wt % based on 100 wt % of the product solution.

In certain embodiments, in step b), the mixture is heated up to an elevated temperature ranging from 100 to 200° C.

In certain embodiments, when the initiator solution is composed of the initiator and the liopphilic solvent, the mixture is heated to an elevated temperature ranging from 100 to 150° C.

In certain embodiments, when the initiator solution is composed of the initiator, the thiol compound and the lipophilic solvent, the mixture is heated to an elevated temperature ranging from 150 to 200° C.

In certain embodiments, the thiol compound is in an amount ranging from 0.04 to 0.5 part by weight based on 10 parts by weight of atactic polypropylene.

Without wishing to be bound by theory, possible chemical reactions involving atactic polypropylene, maleic anhydride, and the initiator are demonstrated in Scheme 1 (see Zhu, Y., An, L., & Jiang, W. (2003). Monte Carlo simulation of the grafting of maleic anhydride onto polypropylene at higher temperature. Macromolecules, 36(10), 3714-3720).

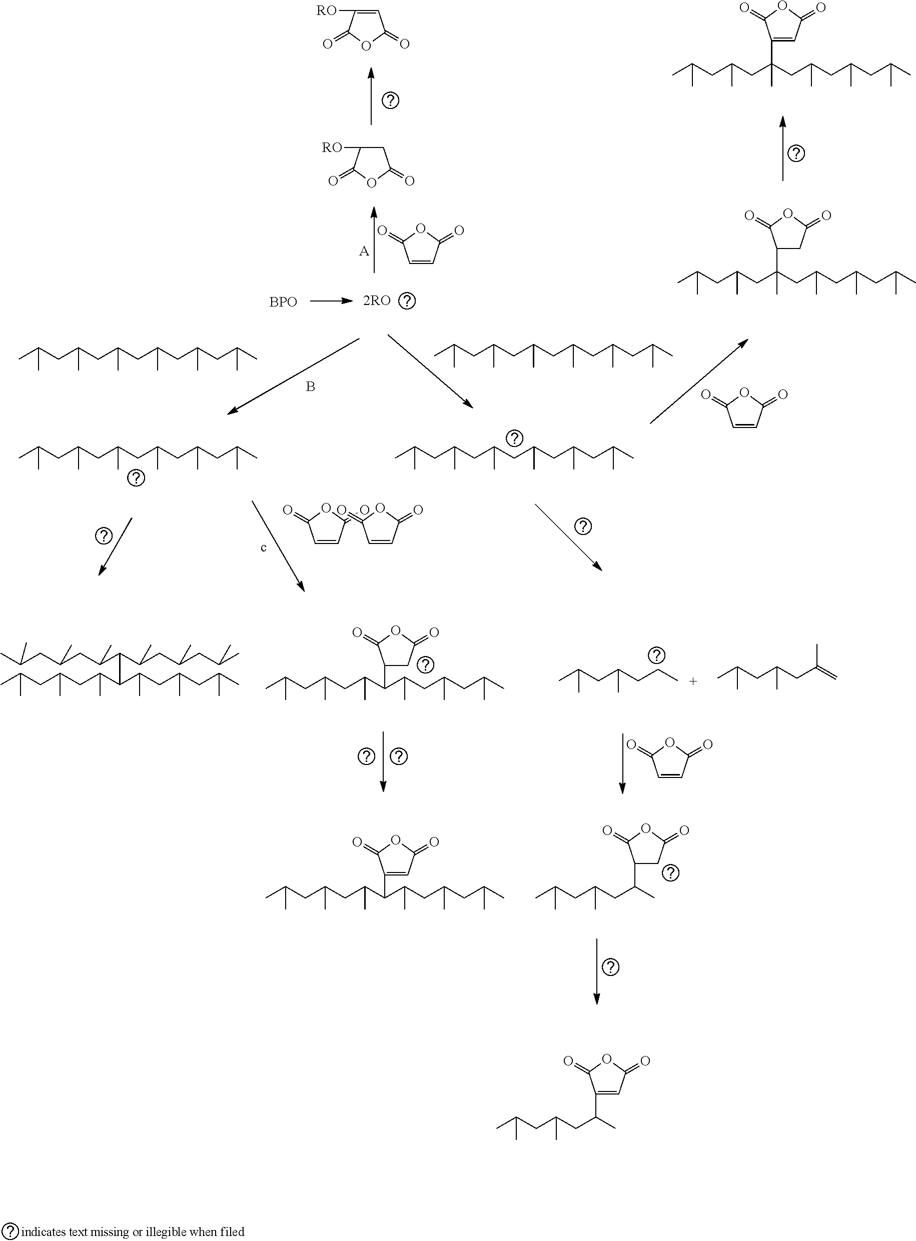

The protective agent containing a cyclic amide or imide ring is used for protecting free radicals produced in a reaction between maleic anhydride and atactic polypropylene free radicals (i.e., route C in Scheme 1) to permit such free radicals to proceed with an intra-molecular transferring reaction (or dismutation, i.e., route D in Scheme 1) so as to form maleic anhydride-grafted atactic polypropylene. In other words, the grafting yield may be increased by forming an unstable transition state, which is produced by the protective agent and such free radicals, followed by the intra-molecular transferring reaction.

A grafting reaction is performed at a temperature ranging from 80 to 200° C. When the grafting reaction is performed at a temperature that is not within the above range, meleic anhydride-grafted atactic polypropylene thus manufactured may have a relatively low grafting yield.

In certain embodiments, the alcohol used for the liquid-liquid extraction in step c) includes methanol, ethanol, acetone, and combinations thereof. The maleic anhydride-grafted atactic polypropylene thus obtained may be purified by washing.

Maleic anhydride-grafted atactic polypropylene manufactured by the method of the disclosure may be used as a crystallizing agent, a compatibilizer, an intercalating agent, a slipping agent, and the like. Maleic anhydride-grafted atactic polypropylene has effects of increasing crystallinity, dyeability, and compatibility.

Examples of the disclosure will be described hereinafter. It is to be understood that these examples are exemplary and explanatory and should not be construed as a limitation to the disclosure.

### EXAMPLES 1-9

### Maleic Anhydride-Grafted Atactic Polypropylene

Maleic anhydride-grafted atactic polypropylenes of Examples 1-9 were manufactured according to following steps. Temperatures and lipophilic solvents used in Examples 1-9 are shown in Table 1.

30 g (10 parts by weight) of atactic polypropylene (purchased from Formosa Petrochemical Corporation, Trade name: aPP), 14.01g (4.67 parts by weight) of maleic anhydride, 24.23g (8.08 parts by weight) of caprolactam, and 500 ml of a lipophilic solvent were mixed at 30° C. to prepare a mixture.

17.25 g (5.75 parts by weight) of dibenzoyl peroxide and 100 ml of a lipophilic solvent were mixed at 30° C. to prepare an initiator solution.

The prepared mixture was heated to the temperature shown in Table 1, followed by adding the initiator solution dropwise to obtain a product solution containing maleic anhydride-grafted atactic polypropylene after complete reaction.

The product solution was then subjected to a liquid-liquid extraction by adding 1500 ml of methanol thereto. The solid thus formed was collected by suction filtration, and was then washed using methanol to obtain maleic anhydride-grafted atactic polypropylenes.

### Measurements:

The maleic anhydride-grafted atactic polypropylene obtained in each of Examples 1-9 was dissolved in xylene to prepare a sample of 5 wt % maleic anhydride-grafted atactic polypropylene. The sample was measured for transmittance using an infrared spectrometer (Rightek Co., Varian 2000, wavenumbers: 1000-3500 cm⁻¹) to obtain an infrared spectrograph. An integrated area (A₁₇₈₀) of a carbonyl (C=) absorption peak for maleic anhydride at wavenumber of 1780 cm⁻¹ and an integrated area (A₁₁₆₇) of a methyl (CH₃) absorption peak for atactic polypropylene at wavenumber of 1167 cm⁻¹ were calculated and an area ratio (A₁₇₈₀/A₁₁₆₇) was obtained by dividing a value of A₁₇₈₀ by a value of A₁₁₆₇. The results are summarized in Table 1. The higher the area ratio, the higher the grafting yield.

### EXAMPLE 10

The procedure for Example 3 was repeated except that 71.05 g (23.68 parts by weight) of maleic anhydride was used in place of the amount of maleic anhydride used in Example 3. The area ratio (A₁₇₈₀/A₁₁₆₇) was obtained and is shown in Table 1 below.

### COMPARATIVE EXAMPLE 1

The procedure for Example 3 was repeated except that caprolactam was not added in Comparative Example 1. The area ratio (A₁₇₈₀/A₁₁₆₇) was obtained and is shown in Table 1.

TABLE 1

| | Maleic | | | |
|---|---|---|---|---|
| | anhydride | | | Area ratio |
| | (pbw) | T (° C.) | Lipophilic solvent | (A₁₇₈₀/A₁₁₆₇) |
| Ex. 1 | 4.67 | 100 | Xylene | 0.558 |
| Ex. 2 | 4.67 | 110 | | 0.684 |
| Ex. 3 | 4.67 | 120 | | 0.967 |
| Ex. 4 | 4.67 | 130 | | 0.810 |
| Ex. 5 | 4.67 | 100 | Chlorobenzene | 0.621 |
| Ex. 6 | 4.67 | 110 | | 0.723 |
| Ex. 7 | 4.67 | 120 | | 1.020 |
| Ex. 8 | 4.67 | 130 | | 0.718 |
| Ex. 9 | 4.67 | 120 | Benzene | 1.560 |
| Ex. 10 | 23.68 | 120 | Xylene | 0.390 |
| Comp. | 4.67 | 120 | Xylene | 0.610 |
| Ex. 1 | | | | |

As shown in Table 1, the amounts of maleic andydride used in Examples 1-9 were 4.67 parts by weight, and the area ratios (A₁₇₈₀/A₁₁₆₇) obtained in these examples range from 0.558 to 1.56. However, when an excess amount of maleic andydride is used, as in Example 10 in which the amount of maleic anhydride was 23.68 parts by weight, the area ratios (A₁₇₈₀/A₁₁₆₇) thus obtained may be significantly decreased. It has been demonstrated that when an excess amount of maleic anhydride is used, an undesirable reaction of Route A in Scheme 1 above may take precedence over Route B, which results in formation of maleic anhydride free radicals so that the grafting yield of maleic anhydride onto atactic polypropylene may be decreased. Therefore, the maleic anhydride is preferably in an amount ranging from 2.3 to 9.4 parts by weight based on 10 parts by weight of the atactic polypropylene.

In Comparative Example 1, caprolactam (i.e., a protective agent containing a cyclic amide ring) was not used, and the area ratio (A₁₇₈₀/A₁₁₆₇) was smaller than that obtained in Example 3, indicating that the grafting yield of maleic anhydride grafted on atactic polypropylene may be increased by using a protective agent having a cyclic amide or imide ring.

In order to determine the grafting yield more precisely, an elemental analyzer was used to analyze the maleic anhydride-grafted atactic polypropylene obtained in each of Examples 3, 7, and 9. The results are shown in Table 2 below.

TABLE 2

| | Ex. 3 | Ex. 7 | Ex. 9 |
|---|---|---|---|
| Lipophilic | xylene | chlorobenzene | benzene |
| solvent | | | |
| C | 84.34 | 84.11 | 83.82 |
| H | 13.97 | 13.94 | 13.86 |
| Grafting | 1.53 | 1.78 | 2.13 |
| yield (mole %) | | | |
| Grafting | 3.60 | 4.20 | 5.03 |
| amount (wt %) | | | |

Regarding calculation of the grafting yield, Example 3 is taken as an example for further explanation.
O: 100%-84.34%-13.97%=1.69%;
C: O (molar ratio)=(84.34/12):(1.69/16)=199.67:3; Grafting yield (mole%):
(199.67-7)/3=64.22, and [1/(1+64.22)]×100%=1.53%;
Grafting yield (wt %):
[(1.53×99)/(100×42)]×100%=3.6%.

As shown in Table 2, the grafting yield and the grafting amount of maleic anhydride grafted on atactic polypropylene were actually increased by the method of the disclosure. In addition, when benzene was used as the lipophilic solvent, the grafting yield and the grafting amount were significantly increased.

### EXAMPLES 11-14

### Maleic Anhydride-Grafted Atactic Polypropylene

Maleic anhydride-grafted atactic polypropylenes of Examples 11-14 were manufactured according to following steps. Temperatures and lipophilic solvents used in Examples 11-14 are shown in Table 3 below.

30 g (10 parts by weight) of atactic polypropylene (purchased from Formosa Petrochemical Corporation, Trade name: aPP), 7.00g (2.33 parts by weight) of maleic anhydride, 1.01 g (0.34 part by weight) of caprolactam, and 70 g of a lipophilic solvent were mixed at 30° C. to prepare a mixture.

9.66 g (3.22 parts by weight) of dicumyl peroxide, 0.195 g (0.07 part by weight) of pentaerythritol tetra(3-mercapto butyrate), and 20 g of a lipophilic solvent were mixed at 30° C. to prepare an initiator solution. The prepared mixture was heated to the temperature shown in Table 3, followed by adding the initiator solution dropwise to obtain a product solution containing maleic anhydride-grafted atactic polypropylene after complete reaction.

The product solution was then subjected to a liquid-liquid extraction by adding 1500 ml of methanol thereto. The solid thus formed was collected by suction filtration, and was then washed using methanol to obtain maleic anhydride-grafted atactic polypropylenes.

TABLE 3

| | | | Area ratio |
|---|---|---|---|
| | T (° C.) | Lipophilic solvent | (A₁₇₈₀/A₁₁₆₇) |
| Ex. 11 | 160 | Benzene | 2.48 |
| Ex. 12 | 165 | Benzene | 2.43 |
| Ex. 13 | 170 | Benzene | 2.46 |
| Ex. 14 | 180 | Benzene | 2.60 |

As shown in Table 3, the area ratios obtained in Examples 11-14 are relatively large compared to those obtained in Examples 1-10 and Comparative Example 1, indicating that the grafting yield of maleic anhydride grafted on atactic polypropylene may be further increased by including the thiol compound in the initiator solution.

### EXAMPLES 15 and 16

### Maleic Anhydride-Grafted Atactic Polypropylene

Maleic anhydride-grafted atactic polypropylenes of Examples 15 and 16 were manufactured according to the following steps. Temperatures and lipophilic solvents used in Examples 15 and 16 are shown in Table 4 below.

30 g (10 parts by weight) of atactic polypropylene (purchased from Formosa Petrochemical Corporation, Trade name: aPP), 7.00g (2.33 parts by weight) of maleic anhydride, caprolactam, and 70 g of a lipophilic solvent were mixed at 30° C. to prepare a mixture.

9.66 g (3.22 parts by weight) of dicumyl peroxide, 0.195 g (0.07 part by weight) of pentaerythritol tetra(3-mercapto butyrate), and 20 g of a lipophilic solvent were mixed at 30° C. to prepare an initiator solution. The prepared mixture was heated to 160° C., followed by adding the initiator solution dropwise to obtain a product solution containing maleic anhydride-grafted atactic polypropylene after complete reaction.

The product solution was then subjected to a liquid-liquid extraction by adding 1500 ml of methanol thereto. The solid thus formed was collected by suction filtration, and was then washed using methanol to obtain maleic anhydride-grafted atactic polypropylenes.

TABLE 4

| | | | Area |
|---|---|---|---|
| | | Lipophilic | ratio |
| | Caprolactam | solvent | (A₁₇₈₀/A₁₁₆₇) |
| Ex. 15 | 2.03 g | Benzene | 2.33 |
| | (0.68 pbw) | | |
| Ex. 16 | 1.01 g | Benzene | 2.77 |
| | (0.34 pbw) | | |

As shown in Table 4, the area ratios obtained in Examples 15 and 16 are relatively large, indicating that the grafting yield of maleic anhydride grafted on atactic polypropylene may be further increased by using the thiol compound and the protective agent containing a cyclic amide or imide ring together in the method of the disclosure. In addition, it is found that the area ratio (corresponding to the grafting yield) obtained in Example 16, in which a relatively small amount of caprolactam (i.e., the protective agent) was used, is relatively large compared to that obtained in Example 15. It is demonstrated that the protection capability of the protective agent and the chain-transferring capability of the thiol compound are simultaneously inhibited by a reaction between the protective agent and the thiol compound. Therefore, when the protective agent and the thiol compound are used together in the method of the disclosure, the relative amounts thereof should be adjusted properly. APPLICATION EXAMPLES 1-3

### Maleic Anhydride-Grafted Atactic Polypropylene Compositions

Maleic anhydride-grafted atactic polypropylene manufactured in Example 4 in amounts shown in Table 5, 90 parts by weight of polypropylene, and 10 parts by weight of Nylon 6 were blended in a plastometer (Brabender, Plasti-corder PL2000, 240° C., 100 rpm) to prepare compositions.

### COMPARATIVE APPLICATION EXAMPLE 1

The procedure for Application Examples 1-3 was repeated to prepare a composition except that maleic anhydride-grafted atactic polypropylene manufactured in Example 4 was not added.

### Measurements:

1. Thermal Property Analysis: The thermal property analysis of each of the compositions of Application Examples 1-3 and Comparative Application Example 1 was performed using a differential scanning calorimeter (DSC). The following steps were conducted for the analysis: heating from 25° C. at a rate of 10° C./min to 260 ° C.; and then cooling from 260° C. at a rate of 10° C./min to 25° C. The results are shown in Table 5 below.

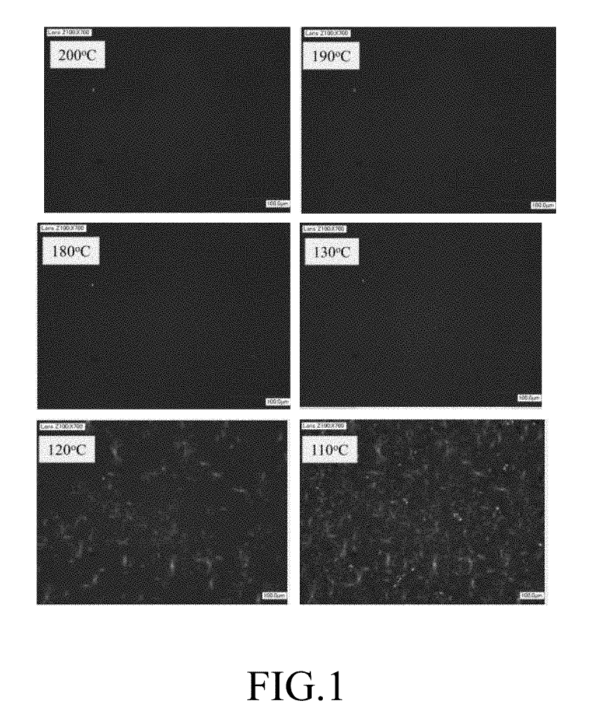

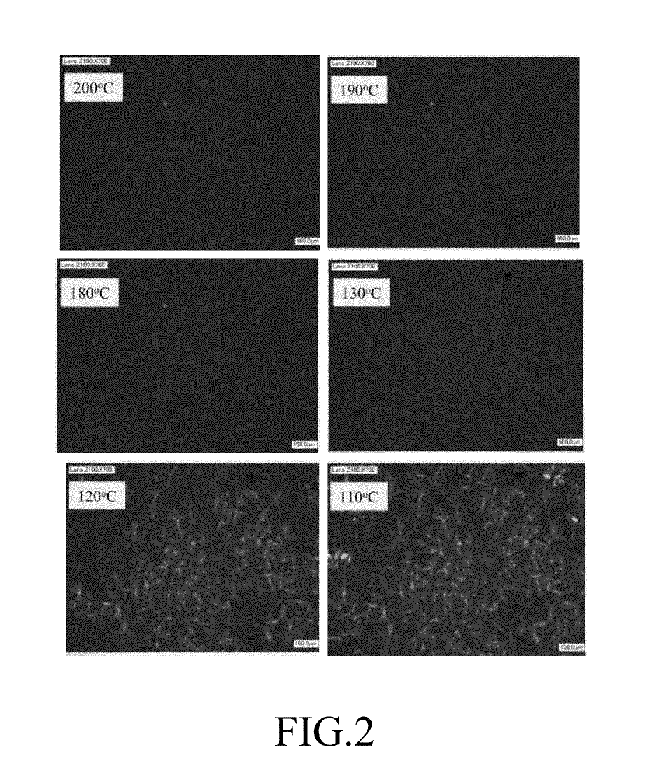

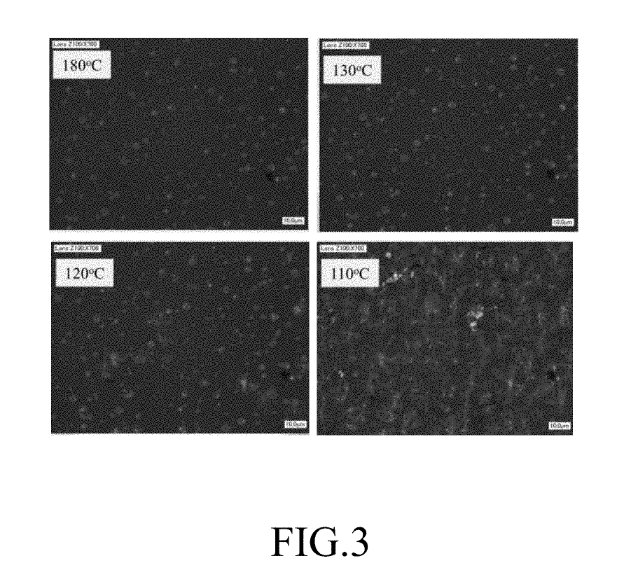

2. Appearance Analysis: The appearance of 2-5 mg of a sample of each of the compositions obtained in Application Examples 1 and 3 and Comparative Application Example 1 was observed using a polarizing microscope. The results are shown in FIGS. 1 to 3. FIG. 1 is the results for the sample of the composition of Application Example 1. FIG. 2 is the results for the sample of the composition of Application Example 3. FIG. 3 is the results for the sample of the composition of Comparative Application Example 1.

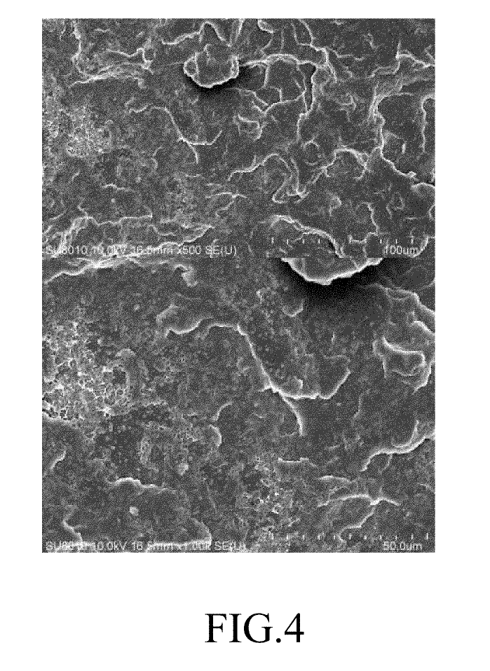

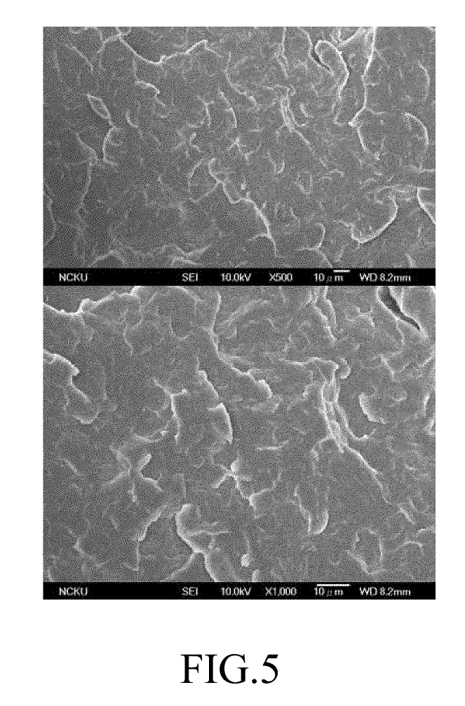

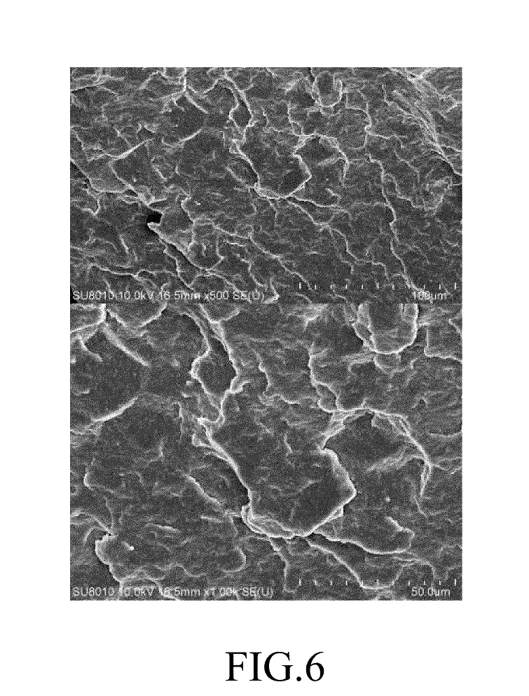

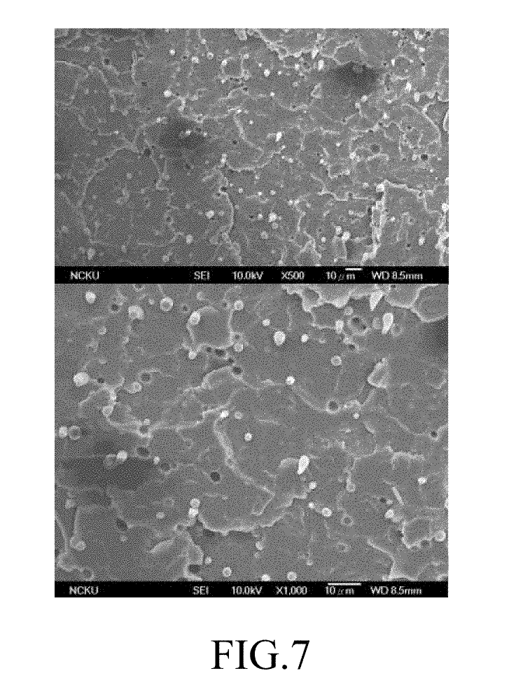

3. Fractured Surface Analysis: A sample of each of the compositions obtained in Application Examples 1-3 and Comparative Application Example 1 was cooled using liquid nitrogen for 3 minutes. The cooled sample was fractured and the fractured surface thereof was observed using a polarizing microscope. The results are shown in FIGS. 4 to 7. FIG. 4 is the result for the sample of the composition of Application Example 1. FIG. 5 is the result for the sample of the composition of Application Example 2. FIG. 6 is the result for the sample of the composition of Application Example 3. FIG. 7 is the result for the sample of the composition of Comparative Application Example 1.

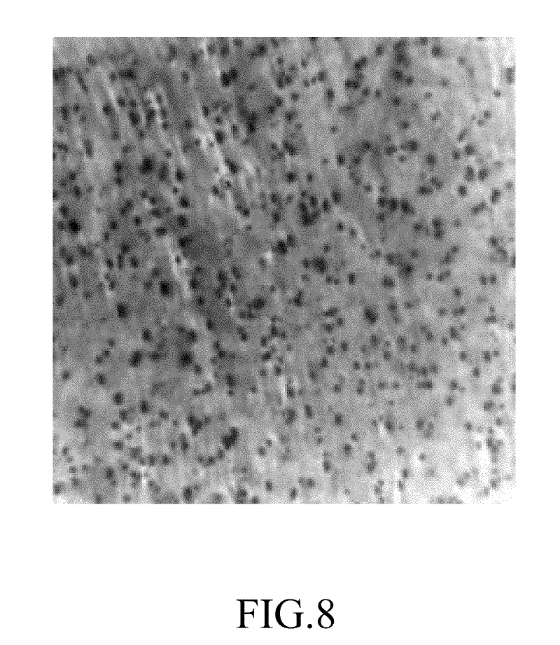

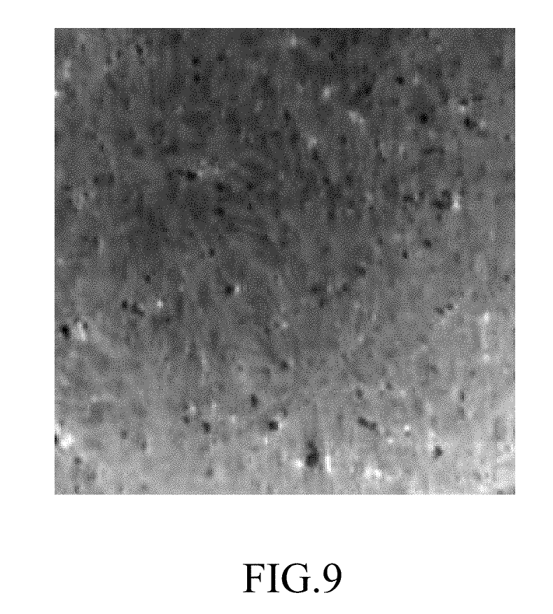

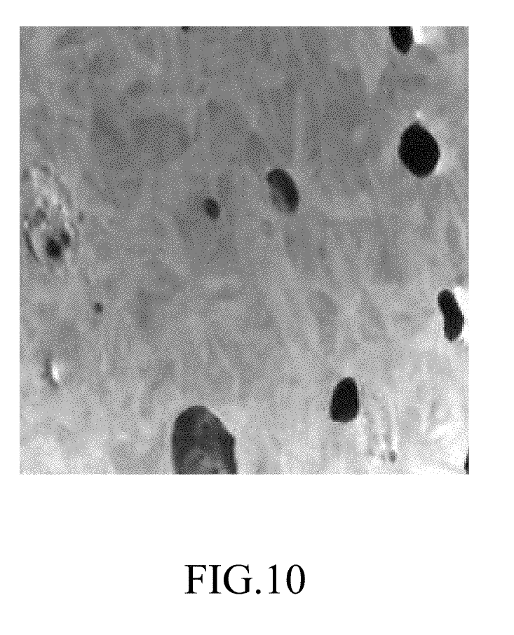

4. Microstructure Analysis: 10-20 mg of each of the compositions obtained in Application Examples 2 and 3 and Comparative Application Example 1 was embedded in an epoxy resin, followed by solidifying and slicing to prepare a sample. The microstructure of the sample was observed using a transmission electron microscope. The results are shown in FIGS. 8 to 10. FIG. 8 is the result for the sample of the composition of Application Example 2. FIG. 9 is the result for the sample of the composition of Application Example 3. FIG. 10 is the result for the sample of the composition of Comparative Application Example 1.

TABLE 5

| | | | | Comp. |
|---|---|---|---|---|
| | App. | App. | App. | App. |
| | Ex. 1 | Ex. 2 | Ex. 3 | Ex. 1 |
| Maleic | 3 | 5 | 10 | 0 |
| anhydride-grafted | | | | |
| atactic | | | | |
| polypropylene | | | | |
| (pbw) | | | | |

| | | | | | |
|---|---|---|---|---|---|
| Heating | ΔHₘ* | 60.4 | 67.9 | 70.3 | 66 |
| | (J/g) | | | | |
| | Tm(° C.) | 162.1 | 164.4 | 163.8 | 162.7 |
| Cooling | ΔHₘ | 73.8 | 81.7 | 81.6 | 75.12 |
| | (J/g) | | | | |
| | Tₘ(° C.) | 115.3 | 116.2 | 114.12 | 116.3 |

*ΔHₘ: melting enthalpy

As shown in Table 5, it is found that when maleic anhydride-grafted atactic polypropylene in an amount larger than 5 parts by weight is used in a polypropylene composition, ΔHₘ and ΔHₘ of the composition thus made are relatively high, indicating that maleic anhydride-grafted atactic polypropylene manufactured by the method of the disclosure maybe used as a nucleating agent for enhancing crystallinity of polypropylene.

As shown in FIGS. 1-3, the compositions of Application Examples 1 and 2 formed a significant amount of intense crystalline particles of relatively small sizes when the temperature was reduced to 120 ° C., whereas the composition of Comparative Application Example 1 formed a significant amount of crystalline particles when the temperature was reduced to 110 ° C., which is lower than that in Application Examples 1 and 2. In addition, the size of the crystalline particles formed from the compositions of Application Examples 1 and 2 is about 10 μm, whereas the size of the crystalline particles formed from the composition of Comparative Application Example 1 is about 50 μm, which is relatively large compared to the size of the crystalline particles formed from the compositions of Application Examples and 2. It is demonstrated again that maleic anhydride-grafted atactic polypropylene manufactured by the method of the disclosure may be used as a nucleating agent for enhancing crystallinity of polypropylene.

Small particles were observed in the sample of the composition of Comparative Application Example 1 shown in FIG. 7, indicating a phase separation caused by incompatibility between polypropylene and nylon 6. Such small particles were not seen in FIGS. 4-6, which are the results for the compositions of Application Examples 1-3. It is demonstrated that maleic anhydride-grafted atactic polypropylene manufactured by the method of the disclosure maybe used as a compatibilizer for enhancing the compatibility between polypropylene and nylon 6.

It is found from the results shown in FIGS. 8 and 9 that nylon 6 is dispersed in a polypropylene matrix homogeneously. However, it is found from the result shown in FIG. 10 that nylon 6 is dispersed in a form of relatively large particles in the polypropylene matrix heterogeneously. It is likewise demonstrated that maleic anhydride-grafted polypropylene manufactured by the method of the disclosure may be used as a compatibilizer for enhancing the compatibility between polypropylene and nylon 6.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. Amethod for manufacturing a maleic anhydride-grafted atactic polypropylene, comprising the steps of:
a) mixing atactic polypropylene, maleic anhydride, a protective agent containing a cyclic amide or imide ring, and a first solvent to prepare a mixture, wherein a ratio of an amount of the maleic anhydride to an amount of the atactic polypropylene is less than 1; and
b) heating the mixture to an elevated temperature and adding an initiator solution dropwise to the mixture to obtain a product solution containing the maleic anhydride-grafted atactic polypropylene.

2. The method according to claim 1, wherein the first solvent is a lipophilic solvent.

3. The method according to claim 1, wherein the maleic anhydride is in an amount ranging from 2.3 to 9.4 parts by weight based on 10 parts by weight of the atactic polypropylene.

4. The method according to claim 1, wherein the elevated temperature ranges from 80° C. to 200° C.

5. The method according to claim 1, wherein the protective agent is selected from the group consisting of propiolactam, butyrolactam, valerolactam, caprolactam, 2-pyrrolidinone, succinimide, and combinations thereof.

6. The method according to claim 2, wherein the lipophilic solvent is selected from the group consisting of chlorobenzene, xylene, benzene, toluene, and combinations thereof.

7. The method according to claim 1, wherein the protective agent is in an amount ranging from 2.6 to 16.2 parts by weight based on 10 parts by weight of the atactic polypropylene.

8. The method according to claim 1, wherein step a) is performed at a temperature ranging from 20 to 50° C.

9. The method according to claim 1, wherein the initiator solution contains an initiator and a second solvent.

10. The method according to claim 9, wherein the second solvent is the same as the first solvent.

11. The method according to claim 9, wherein the second solvent is a lipophilic solvent.

12. The method according to claim 9, wherein the initiator is in an amount ranging from 2.8 to 17.3 parts by weight based on 10 parts by weight of the atactic polypropylene.

13. The method according to claim 9, wherein the initiator solution further includes a thiol compound.

14. The method according to claim 1, wherein a total amount of the atactic polypropylene, the maleic anhydride, the protective agent, and the initiator ranges from 5 to 25 wt % based on 100 wt % of the product solution.

15. The method according to claim 13, wherein a total amount of the atactic polypropylene, the maleic anhydride, the protective agent, the initiator, and the thiol compound ranges 5 to 25 wt % based on 100 wt % of the product solution.

16. The method according to claim 1, further comprising a step of subjecting the product solution to a liquid-liquid extraction using alcohol to remove the maleic anhydride-grafted atactic polypropylene from the product solution.
